(19) United States
(12) Patent Application Publication
(10) Pub. No.: US 2026/0295619 A1
(43) Pub. Date: Oct. 1, 2026

(54) SPRAYING SYSTEM AND CONSTRUCTION METHOD FOR IMPROVING BOND FORCE BETWEEN VEGETATION SUBSTRATE AND SLOPE SURFACE

(71) Applicant: China Three Gorges University, Yichang (CN)

(72) Inventors: Daxiang Liu, Yichang (CN); Xingfeng Zhang, Yichang (CN); Yueshu Yang, Yichang (CN); Yun Hu, Yichang (CN); Bingqin Zhao, Yichang (CN); Xudong Hu, Yichang (CN); Yexiong Zhou, Yichang (CN); Kaile Wang, Yichang (CN); Yu Ding, Yichang (CN); Mingyi Li, Yichang (CN); Dong Xia, Yichang (CN); Bin Wu, Yichang (CN); Yang Xu, Yichang (CN); Wennian Xu, Yichang (CN)

(21) Appl. No.: 19/630,380

(22) Filed: Mar. 26, 2026

(30) Foreign Application Priority Data
Mar. 28, 2025 (CN) 202510383110.9

(51) Int. Cl. B05B 12/08; B05B 12/12; B05B 13/00; B05B 15/62

(52) U.S. Cl. CPC B05B 12/085; B05B 12/124; B05B 13/005; B05B 15/62

(57) ABSTRACT

A spraying system and a construction method for improving bond force between vegetation substrate and slope surface, comprising a spray gun body, a movable bracket, a nozzle velocity calculation module, and a compressor module; the spray gun body is installed at a top of the movable bracket, and the spray gun body is connected to the compressor module; the spray gun body is installed with the nozzle velocity calculation module; the nozzle velocity calculation module is connected to the compressor module and controls a spraying velocity. When the spray gun continuously changes its horizontal deflection angle, pitch angle, and the slant distance between the spray gun and the slope surface while spraying the repair substrate, the nozzle velocity calculation module can automatically retrieve relevant parameters for computation to match the nozzle velocity; subsequently, the compressor module adjusts the compression strength based on parameters such as substrate viscosity and density.

### TECHNICAL FIELD

The invention belongs to the technical field of slope construction, in particular to a spraying system and a construction method for improving bond force between vegetation substrate and slope surface.

### BACKGROUND ART

Slopes, serving as the intersection between natural and man-made environments, were originally characterized by dense vegetation and complex ecosystems. However, frequent engineering and construction activities often destroy this vegetation, leading to soil exposure, which in turn triggers a series of ecological issues such as water loss and soil erosion. To address these challenges, ecological restoration technologies have emerged, aiming to reconstruct or restore slope vegetation communities through artificial means to maintain and recover biodiversity.

Ecological slope protection technology is an effective method specifically designed for slope restoration. Based on factors such as the slope's geographical location and rock characteristics, materials including soil, cementing agents, ecological agents, and plant seeds are mixed in specific proportions with water to form an ecological substrate. Subsequently, professional spraying equipment is used to apply this substrate onto the slope surface to achieve ecological recovery.

The incident velocity and angle of the substrate are critical factors affecting the bond force at the substrate-slope interface. Improper handling leads to two main issues: either insufficient bond force causing the substrate to peel off, or excessive kinetic energy at the moment of impact causing the material to bounce off the slope. Consequently, operators must frequently adjust the spray gun parameters during practical operations, which undoubtedly increases construction difficulty. It is noteworthy that most widely used spray guns currently operate at a constant velocity and cannot promptly adjust the spraying speed for different areas of the slope. This results in significant variations in interface bond force across the slope, making the substrate prone to localized peeling and collapse in later stages. Furthermore, the use of spray guns requires operators to possess specific professional skills and experience to ensure coating effectiveness and construction quality. However, in actual engineering projects, the skill levels of operators vary significantly, which to some extent compromises the application quality of the vegetation substrate.

### SUMMARY OF THE INVENTION

The purpose of the invention is to provide a spraying system and a construction method for improving bond force between vegetation substrate and slope surface. This spraying system, when the spray gun continuously changes its pitch angle, horizontal deflection angle and distance while spraying the repair substrate along the slope, utilizes a nozzle velocity calculation module that can automatically retrieve relevant parameters for computation to match the nozzle speed; subsequently, the compressor module adjusts the compression strength based on parameters such as the substrate viscosity, ultimately achieving the optimal incident speed on the slope surface to ensure that the bond force between vegetation substrate and slope surface is consistent across different positions on the slope. This substrate spraying system effectively improves the spraying efficiency while ensuring the bond force between vegetation substrate and slope surface.

To achieve the above technical features, the objective of this invention is as follows: a spraying system for improving bond force between vegetation substrate and slope surface, comprising a spray gun body, a movable bracket, a nozzle velocity calculation module, and a compressor module;
the spray gun body is installed at a top of the movable bracket, and the spray gun body is connected to the compressor module;
the spray gun body is installed with the nozzle velocity calculation module;
the nozzle velocity calculation module is connected to the compressor module and controls a spraying velocity.

Preferably, the spray gun body comprises a nozzle, and a tail end of the nozzle is connected to a material delivery pipeline.

Preferably, the movable bracket comprises a movable base, a top of the movable bracket is provided with longitudinal horizontal sliding rails, transverse horizontal sliding rails are slidably installed between the longitudinal horizontal sliding rails, a lifting arm is slidably installed on the transverse horizontal sliding rails, and a top end of the lifting arm is provided with a rotary joint;
the nozzle is installed on the rotary joint.

Preferably, the compressor module 4 comprises a substrate storage device, a bottom outlet of the substrate storage device is connected to the material delivery pipeline, the substrate storage device is connected to a compressor via an air supply pipeline, the compressor is installed with a compressor controller, a substrate parameter measurement device is installed at a bottom of the substrate storage device, and the substrate parameter measurement device is connected to the compressor controller.

Preferably, the nozzle velocity calculation module comprises a gyroscope, a laser rangefinder, and a controller; the gyroscope and the laser rangefinder are located on either side of the nozzle and are used to measure a pitch angle of the spray gun, a horizontal deflection angle, and a slant distance between the spray gun and the slope; the controller is connected to the compressor controller of the compressor module.

Preferably, the nozzle velocity calculation module is used to deduce an optimal incident velocity V_{B} on the slope surface, and thereby calculating a nozzle velocity V_{nozzle};
the controller runs an incident angle calculation function:

$$β = β ( α , γ , θ ) = {β}_{0} ( 1 - \frac{02 α}{90} ) ( 1 + \frac{0.15 γ}{90} ) ( 1 - \frac{0.1 θ}{90} ) ;$$

a functional relationship between the optimal incident velocity V_{B} and an incident angle β:

$${V}_{B} = {V}_{B} ( β ) = {{V}_{B 0} ( \frac{β}{90} )}^{0.8} [ 1 + \frac{0.5 ( β - 90 )}{90} ] ;$$

a functional relationship between the spray gun nozzle velocity V_{nozzle}, the optimal incident velocity V_{B}, the pitch angle of the spray gun, and the slant distance L between the spray gun and the slope;

$${V}_{n o z z l e} = {V}_{n o z z l e} ( {V}_{B} , γ , L ) = {V}_{B} ( 1 + 0 \text{.2} L ) ( 1 + \frac{0.1 γ}{90} ) ;$$

in the formula, α is the slope angle; β is the incident angle; β₀ is a reference incident angle; V_{B} is the optimal incident velocity; V_{B0} is a reference incident velocity; V_{nozzle} is the nozzle velocity; γ is the pitch angle of the spray gun; θ is the horizontal deflection angle; L is the slope distance between the spray gun and the slope.

Preferably, the compressor module is used to match a compression intensity of the compressor in order to achieve the nozzle velocity;
the compressor controller establishes a functional relationship between the compression intensity of the compressor, a substrate consistency, apparent density parameters, and the nozzle velocity:

$$P = P ( {V}_{n o z z l e} , {X}_{1} , {X}_{2} , … , {X}_{i} ) = {{P}_{0} ( \frac{{V}_{nozzle}}{20} )}^{1.5} {( \frac{{X}_{1}}{10} )}^{0.3} {( \frac{{X}_{2}}{1.8} )}^{0.8} … {( \frac{{X}_{i}}{{X}_{i 0}} )}^{n} ;$$

in the formula, Xᵢ represents a substrate parameter, including the substrate consistency and the apparent density; Xᵢ₀ is a reference value for the substrate parameter; n is a substrate parameter index; P is the compression intensity of the compressor, P₀ is a reference pressure;

Preferably, a value of β₀ is 85°;
a value of V_{B0} is 12 m/s;
a value of P₀ is 0.5 MPa.

On the other hand, the invention further provides a construction method for improving the bond force between vegetation substrate and slope surface, wherein the construction method uses the spraying system according to any one of claims 7-8 to implement the following steps:
S1: before construction, obtaining the slope angle α, setting a nozzle along a direction perpendicular to an XOY plane, i.e., along a Z-axis, to zero, and setting the pitch angle γ of the spray gun and the horizontal deflection angle θ to zero;
S2: during construction, starting the machine, adjusting a position of the nozzle using the movable bracket, aim at a target area, and rotate the nozzle to change the pitch angle γ of the spray gun and the horizontal deflection angle θ;
S3: measuring the pitch angle γ of the spray gun and the horizontal deflection angle θ using the gyroscope, and transmitting signals to the controller, in combination with the slope angle α, calling the function β(α, γ, θ) to calculate the incident angle β, and then calling the function V_{B}(β) to calculate the optimal slope incident velocity V_{B};
S4: measuring the slant distance L between the spray gun and the slope surface using the laser rangefinder, and transmitting the signal to the controller, in combination with the optimal incident velocity V_{B} on the slope surface and the pitch angle γ of the spray gun, calling the function V_{nozzle} (V_{B}, γ, L) to calculate the nozzle velocity V_{nozzle};
S5: after obtaining the nozzle velocity V_{nozzle}, according to the substrate consistency and the apparent density parameters measured by the substrate parameter measurement device, in combination with the nozzle velocity V_{nozzle}, the compressor controller automatically calls the function P (V_{nozzle}, X₁, X₂, . . . , Xᵢ) to calculate and adjust the compression intensity of the compressor to achieve the above nozzle velocity V_{nozzle};
S6: once the substrate in the current area is sprayed, aiming at a next target area, rotating the spray gun, and repeating S3-S5;
S7: after all target areas are sprayed, turning off the machine.

The invention has the following advantageous effects:
1. in the invention, when the spray gun continuously changes its horizontal deflection angle, pitch angle, and the slant distance between the spray gun and the slope surface while spraying the repair substrate, the nozzle velocity calculation module can automatically retrieve relevant parameters for computation to match the nozzle velocity; subsequently, the compressor module adjusts the compression strength based on parameters such as substrate viscosity, thereby achieving automatic matching of the optimal impact speed for different incident angles and spraying distances, which enhances the bond force between the substrate and the slope surface and improves the long-term effectiveness of ecological slope protection projects;
2. the spraying system of the invention, which improves the bond force between vegetative substrate and slope surfaces through self-adjusting spraying speed, can automatically change its position for substrate spraying via horizontal guide rails, lifting arms, and rotary joints, eliminating the need for workers to climb the slope; instead, operators can simply operate from the bottom of the slope. This reduces reliance on workers' construction skills while ensuring safety;
3. the spraying system of the invention effectively improves the spraying efficiency of the substrate while ensuring the bond force between vegetation substrate and slope surface through self-adjusting spraying speed, thereby enhancing the bond force between the vegetative substrate and slope surface.

### BRIEF DESCRIPTION OF ACCOMPANYING DRAWINGS

The invention will be further described below with reference to the accompanying drawings and embodiments.

FIG. 1 is an overall structural diagram of the spraying system of the invention.

FIG. 2 is a working logic diagram of the spraying system of the invention.

FIG. 3 is a zero-adjustment diagram of the spraying system of the invention during spraying.

FIG. 4 is a diagram of the adjustment process of the spraying system of the invention.

In the figures:

1 spray gun body, 2 movable bracket, 3 nozzle velocity calculation module, 4 compressor module, 11 nozzle, 12 material delivery pipeline, 21 movable base, 22 longitudinal horizontal guide rail, 23 lifting arm, 24 rotary joint, 25 transverse horizontal sliding rail, 31 gyroscope, 32 laser rangefinder, 33 controller, 41 substrate parameter measurement device, 42 substrate storage device, 43 compressor controller, 44 compressor, 45 air supply pipeline.

### SPECIFIC EMBODIMENT OF THE INVENTION

The embodiments of the invention will be further described below with reference to the accompanying drawings.

### Embodiment 1

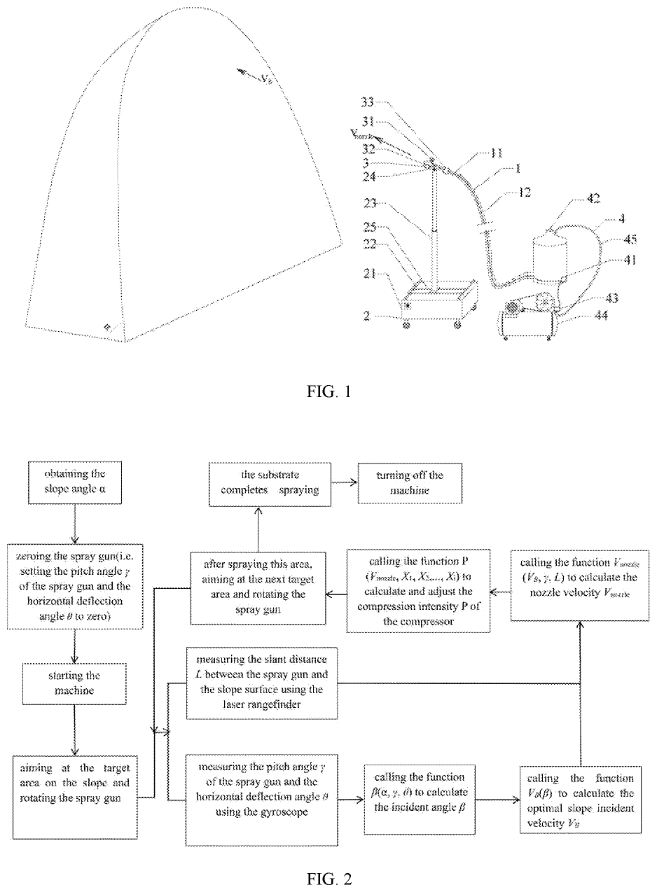

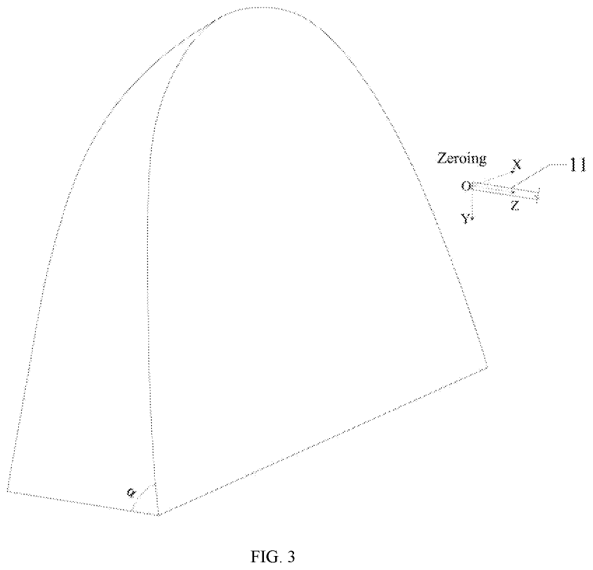

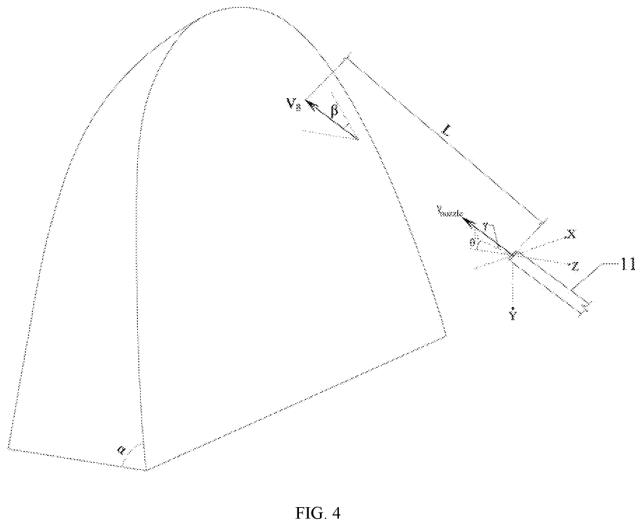

Referring to FIGS. 1-4, a spraying system for improving bond force between vegetation substrate and slope surface, comprising a spray gun body 1, a movable bracket 2, a nozzle velocity calculation module 3, and a compressor module 4; the spray gun body 1 is installed at a top of the movable bracket 2, and the spray gun body 1 is connected to the compressor module 4; the spray gun body 1 is installed with the nozzle velocity calculation module 3; the nozzle velocity calculation module 3 is connected to the compressor module 4 and controls a spraying velocity. When the spray gun continuously changes its pitch angle, horizontal deflection angle and distance while spraying the repair substrate along the slope, utilizes a nozzle velocity calculation module that can automatically retrieve relevant parameters for computation to match the nozzle speed; subsequently, the compressor module adjusts the compression strength based on parameters such as the substrate viscosity, ultimately achieving the optimal incident speed on the slope surface to ensure that the bond force between vegetation substrate and slope surface is consistent across different positions on the slope. This substrate spraying system effectively improves the spraying efficiency while ensuring the bond force between vegetation substrate and slope surface.

Further, the spray gun body 1 comprises a nozzle 11, and a tail end of the nozzle 11 is connected to a material delivery pipeline 12. By using the nozzle 11, it is configured for the spraying of repair substrate.

Further, the movable bracket 2 comprises a movable base 21, a top of the movable bracket 2 is provided with longitudinal horizontal sliding rails 22, transverse horizontal sliding rails 25 are slidably installed between the longitudinal horizontal sliding rails 22, a lifting arm 23 is slidably installed on the transverse horizontal sliding rails 25, and a top end of the lifting arm 23 is provided with a rotary joint 24. The movable bracket 2 is configured to adjust the position of the nozzle 11, thereby changing the spraying position and angle of the nozzle 11. In the specific adjustment process, the longitudinal horizontal guide rails 22 and the transverse horizontal guide rails 25 allow for the adjustment of the position of the nozzle 11 on the plane, while the rotary joint 24 enables the adjustment of the angle of the nozzle.

Further, the nozzle 11 is installed on the rotary joint 24. The rotary joint 24 enables the adjustment of the angle of the nozzle.

Further, the compressor module 4 comprises a substrate storage device 42, a bottom outlet of the substrate storage device 42 is connected to the material delivery pipeline 12, the substrate storage device 42 is connected to a compressor 44 via an air supply pipeline 45, the compressor 44 is installed with a compressor controller 43, a substrate parameter measurement device 41 is installed at a bottom of the substrate storage device 42, and the substrate parameter measurement device 41 is connected to the compressor controller 43. The compressor module 4 is configured to provide the power for spraying the repair substrate. During operation, the compressor 44 provides the compressed power, which supplies the repair substrate to the nozzle 11 and ejects it from the nozzle 11. The compressor controller 43 is used to control the compressor 44.

Further, the nozzle velocity calculation module 3 comprises a gyroscope 31, a laser rangefinder 32, and a controller 33; the gyroscope 31 and the laser rangefinder 32 are located on either side of the nozzle 11 and are used to measure a pitch angle of the spray gun, a horizontal deflection angle, and a slant distance between the spray gun and the slope; the controller 33 is connected to the compressor controller 43 of the compressor module 4. The nozzle velocity calculation module 3 is configured to achieve the measurement of the nozzle angle. This facilitates the subsequent real-time adjustment of the spraying angle of the nozzle 11 through calculations to achieve optimal spraying effects.

Further, the nozzle velocity calculation module 3 is used to deduce an optimal incident velocity V_{B} on the slope surface, and thereby calculating a nozzle velocity V_{nozzle},
the controller 33 runs an incident angle calculation function:

$$β = β ( α , γ , θ ) = {β}_{0} ( 1 - \frac{0.2 α}{90} ) ( 1 + \frac{0.15 γ}{90} ) ( 1 - \frac{0.1 θ}{90} ) ;$$

a functional relationship between the optimal incident velocity V_{B} and an incident angle β:

$${V}_{B} = {V}_{B} ( β ) = {{V}_{B 0} ( \frac{β}{90} )}^{0.8} [ 1 + \frac{0.5 ( β - 90 )}{90} ] ;$$

a functional relationship between the spray gun nozzle velocity V_{nozzle}, the optimal incident velocity V_{B}, the pitch angle of the spray gun, and the slant distance L between the spray gun and the slope;

$${V}_{nozzle} = {V}_{n o z z l e} ( {V}_{B} , γ , L ) = {V}_{B} ( 1 + 0 \text{.2} L ) ( 1 + \frac{0.1 γ}{90} ) ;$$

in the formula, α is the slope angle; β is the incident angle; β₀ is a reference incident angle; V_{B} is the optimal incident velocity; V_{B0} is a reference incident velocity; V_{nozzle} is the nozzle velocity; γ is the pitch angle of the spray gun; θ is the horizontal deflection angle; L is the slope distance between the spray gun and the slope.

Further, the compressor module 4 is used to match a compression intensity of the compressor 44 in order to achieve the nozzle velocity;
the compressor controller 43 establishes a functional relationship between the compression intensity of the compressor 44, a substrate consistency, apparent density parameters, and the nozzle velocity:

$$P = P ( {V}_{nozzle} , {X}_{1} , {X}_{2} , … , {X}_{1} ) = {{P}_{0} ( \frac{{V}_{nozzle}}{20} )}^{1.5} {( \frac{{X}_{1}}{10} )}^{0.3} {( \frac{{X}_{2}}{18} )}^{0.8} … {( \frac{{X}_{i}}{{X}_{i 0}} )}^{n} ;$$

in the formula, Xᵢ represents a substrate parameter, including the substrate consistency and the apparent density; Xᵢ₀ is a reference value for the substrate parameter; n is a substrate parameter index; P is the compression intensity of the compressor, P₀ is a reference pressure;

Further, a value of β₀ is 85°;
a value of V_{B0} is 12 m/s;
a value of P₀ is 0.5 MPa.

### Embodiment 2

The invention further provides a construction method for improving the bond force between vegetation substrate and slope surface, wherein the construction method uses the spraying system to implement the following steps:
S1: before construction, obtaining the slope angle α, setting a nozzle along a direction perpendicular to an XOY plane, i.e., along a Z-axis, to zero, and setting the pitch angle γ of the spray gun and the horizontal deflection angle θ to zero;
S2: during construction, starting the machine, adjusting a position of the nozzle 11 using the movable bracket 2, aim at a target area, and rotate the nozzle 11 to change the pitch angle γ of the spray gun and the horizontal deflection angle θ;
S3: measuring the pitch angle γ of the spray gun and the horizontal deflection angle θ using the gyroscope 31, and transmitting signals to the controller 33, in combination with the slope angle α, calling the function β(α, γ, θ) to calculate the incident angle β, and then calling the function V_{B}(β) to calculate the optimal slope incident velocity V_{B};
S4: measuring the slant distance L between the spray gun and the slope surface using the laser rangefinder 32, and transmitting the signal to the controller 33, in combination with the optimal incident velocity V_{B} on the slope surface and the pitch angle γ of the spray gun, calling the function V_{nozzle}(V_{B}, γ, L) to calculate the nozzle velocity V_{nozzle};
S5: after obtaining the nozzle velocity V_{nozzle}, according to the substrate consistency and the apparent density parameters measured by the substrate parameter measurement device 41, in combination with the nozzle velocity V_{nozzle}, the compressor controller 43 automatically calls the function P (V_{nozzle}, X₁, X₂, . . . , Xᵢ) to calculate and adjust the compression intensity of the compressor 44 to achieve the above nozzle velocity V_{nozzle};
S6: once the substrate in the current area is sprayed, aiming at a next target area, rotating the spray gun, and repeating S3-S5;
S7: after all target areas are sprayed, turning off the machine.

1. A spraying system for improving bond force between vegetation substrate and slope surface, comprising a spray gun body, a movable bracket, a nozzle velocity calculation module, and a compressor module;
the spray gun body is installed at a top of the movable bracket, and the spray gun body is connected to the compressor module;
the spray gun body is installed with the nozzle velocity calculation module;
the nozzle velocity calculation module is connected to the compressor module and controls a spraying velocity.

2. The spraying system for improving the bond force between vegetation substrate and slope surface of claim 1, wherein the spray gun body comprises a nozzle, and a tail end of the nozzle is connected to a material delivery pipeline.

3. The spraying system for improving the bond force between vegetation substrate and slope surface of claim 2, wherein the movable bracket comprises a movable base, a top of the movable bracket is provided with longitudinal horizontal sliding rails, transverse horizontal sliding rails are slidably installed between the longitudinal horizontal sliding rails, a lifting arm is slidably installed on the transverse horizontal sliding rails, and a top end of the lifting arm is provided with a rotary joint;
the nozzle is installed on the rotary joint.

4. The spraying system for improving the bond force between vegetation substrate and slope surface of claim 2, wherein the compressor module 4 comprises a substrate storage device, a bottom outlet of the substrate storage device is connected to the material delivery pipeline, the substrate storage device is connected to a compressor via an air supply pipeline, the compressor is installed with a compressor controller, a substrate parameter measurement device is installed at a bottom of the substrate storage device, and the substrate parameter measurement device is connected to the compressor controller.

5. The spraying system for improving the bond force between vegetation substrate and slope surface of claim 4, wherein the nozzle velocity calculation module comprises a gyroscope, a laser rangefinder, and a controller; the gyroscope and the laser rangefinder are located on either side of the nozzle and are used to measure a pitch angle of the spray gun, a horizontal deflection angle, and a slant distance between the spray gun and the slope; the controller is connected to the compressor controller of the compressor module.

6. The spraying system for improving the bond force between vegetation substrate and slope surface of claim 5, wherein the nozzle velocity calculation module is used to deduce an optimal incident velocity V_{B} on the slope surface, and thereby calculating a nozzle velocity V_{nozzle},
the controller runs an incident angle calculation function:
$$β = β ( α , γ , θ ) = {β}_{0} ( 1 - \frac{0.2 α}{90} ) ( 1 + \frac{0.15 γ}{90} ) ( 1 - \frac{0.1 θ}{90} ) ;$$
a functional relationship between the optimal incident velocity V_{B} and an incident angle β:
$${V}_{B} = {V}_{B} ( β ) = {{V}_{B 0} ( \frac{β}{90} )}^{0.8} [ 1 + \frac{0.5 ( β - 90 )}{90} ] ;$$
a functional relationship between the spray gun nozzle velocity V_{nozzle}, the optimal incident velocity V_{B}, the pitch angle of the spray gun, and the slant distance L between the spray gun and the slope;
$${V}_{nozzle} = {V}_{n o z z l e} ( {V}_{B} , γ , L ) = {V}_{B} ( 1 + 0 \text{.2} L ) ( 1 + \frac{0.1 γ}{90} ) ;$$
in the formula, α is the slope angle; β is the incident angle; β₀ is a reference incident angle; V_{B} is the optimal incident velocity; V_{B0} is a reference incident velocity; V_{nozzle} is the nozzle velocity; γ is the pitch angle of the spray gun; θ is the horizontal deflection angle; L is the slope distance between the spray gun and the slope.

7. The spraying system for improving the bond force between vegetation substrate and slope surface of claim 6, wherein the compressor module is used to match a compression intensity of the compressor in order to achieve the nozzle velocity;
the compressor controller establishes a functional relationship between the compression intensity of the compressor, a substrate consistency, apparent density parameters, and the nozzle velocity:
$$P = P ( {V}_{nozzle} , {X}_{1} , {X}_{2} , … , {X}_{i} ) = {{P}_{0} ( \frac{{V}_{n o z z l e}}{20} )}^{1.5} {( \frac{{X}_{1}}{10} )}^{0.3} {( \frac{{X}_{2}}{1.8} )}^{0.8} … {( \frac{{X}_{i}}{{X}_{i 0}} )}^{n} ;$$
in the formula, Xᵢ represents a substrate parameter, including the substrate consistency and the apparent density; Xᵢ₀ is a reference value for the substrate parameter; n is a substrate parameter index; P is the compression intensity of the compressor, P₀ is a reference pressure.

8. The spraying system for improving the bond force between vegetation substrate and slope surface of claim 6, wherein a value of β₀ is 85°; a value of V_{B0} is 12 m/s;
a value of P₀ is 0.5 MPa.

9. A construction method for improving the bond force between vegetation substrate and slope surface, wherein the construction method uses the spraying system according to any one of claims 7-8 to implement the following steps:
S1: before construction, obtaining the slope angle α, setting a nozzle along a direction perpendicular to an XOY plane, i.e., along a Z-axis, to zero, and setting the pitch angle γ of the spray gun and the horizontal deflection angle θ to zero;
S2: during construction, starting the machine, adjusting a position of the nozzle using the movable bracket, aim at a target area, and rotate the nozzle to change the pitch angle γ of the spray gun and the horizontal deflection angle θ;
S3: measuring the pitch angle γ of the spray gun and the horizontal deflection angle θ using the gyroscope, and transmitting signals to the controller, in combination with the slope angle α, calling the function β(α, γ, θ) to calculate the incident angle β, and then calling the function V_{B}(β) to calculate the optimal slope incident velocity V_{B};
S4: measuring the slant distance L between the spray gun and the slope surface using the laser rangefinder, and transmitting the signal to the controller, in combination with the optimal incident velocity V_{B} on the slope surface and the pitch angle γ of the spray gun, calling the function V_{nozzle} (V_{B}, γ, L) to calculate the nozzle velocity V_{nozzle};
S5: after obtaining the nozzle velocity V_{nozzle}, according to the substrate consistency and the apparent density parameters measured by the substrate parameter measurement device, in combination with the nozzle velocity V_{nozzle}, the compressor controller automatically calls the function P (V_{nozzle}, X₁, X₂, . . . , Xᵢ) to calculate and adjust the compression intensity of the compressor to achieve the above nozzle velocity V_{nozzle};
S6: once the substrate in the current area is sprayed, aiming at a next target area, rotating the spray gun, and repeating S3-S5;
S7: after all target areas are sprayed, turning off the machine.
